(19) United States
(12) Patent Application Publication
(10) Pub. No.: US 2006/0168549 A1
(43) Pub. Date: Jul. 27, 2006

(54) User interfaces and methods for displaying attributes of objects and accessing content

(76) Inventors: Eric Chan, Oakland, CA (US); Gerald Chan, San Leandro, CA (US)

Correspondence Address: Gerald Chan, 14021 Seagate Drive, San Leandro, CA, 94577, US

(21) Appl. No.: 11/043,796

(22) Filed: Jan. 25, 2005

(51) Int. Cl. G06F 9/00

(52) U.S. Cl. 715/863

(57) ABSTRACT

A user interface method includes displaying content associated with an object in a first window if the object is selected by performing a first operation using a mouse and without use of a keyboard, and displaying the content in a second window if the object is selected by performing a second operation using the mouse and without use of the keyboard. A user interface method includes informing a user, before an object is selected, that content associated with the object will be displayed in a first window if the object is selected, or that the content will be displayed in a second window if the object is selected. A user interface method includes informing a user, before an object is selected, that a script will be run if the object is selected, wherein the step of informing comprises presenting information at or adjacent to the object.

### BACKGROUND

1. Field of the Invention

The field of the invention relates to computer systems and computer networks, and more particularly, to user interfaces and methods for displaying attributes of objects and/or accessing content associated with objects.

2. Background

Every day, millions of people from all over the world access information using computers. For examples, a computer user can obtain information by downloading web pages from the internet or an intranet. A user can also obtain information stored in a computer memory by using an application or software.

A web page may contain a hyperlink, a selection of which causes information associated with the hyperlink to be displayed. In some cases, when a hyperlink is selected, content currently displayed in a current page (window) is replaced with content associated with the hyperlink. In other cases, when a hyperlink is selected, a new window is displayed and content associated with the hyperlink is displayed within the new window (commonly referred to as “popup”). However, existing interface does not allow a user to know, before a hyperlink is selected, whether a selection of a hyperlink will cause content associated with the hyperlink to be displayed in a current window or in a new window. Sometimes, a selection of a hyperlink will cause content to be displayed in an existing window, when the user wishes the content to be displayed in a new window. In other times, a selection of a hyperlink will cause content to be displayed in a new window, when the user wishes the content to be displayed in an existing window. As such, not knowing how new content associated with a hyperlink will be displayed upon a selection makes navigation of network content, such as web pages, difficult.

In some cases, a user can cause content to be displayed in a new window by selecting the hyperlink while pressing the “shift” key on a keyboard. However, such operation requires the user to look away from a screen in order to look for the “shift” key, thereby making the navigation through web pages cumbersome and difficult. Also, such operation may not work for some hyperlinks that are configured to run scripts in the current window. For example, a hyperlink may be configured to run a script in a current window to create a pop-up. In such case, selecting the hyperlink while pressing the “shift” key will cause the script associated with the hyperlink to be treated as a URL address in the new window, thereby creating an “error” in the new window page.

Similar problems exist when accessing content in a computer memory. For example, when using a navigation tool, such as Window Explorer™, to navigate through files and folders to access desired content, content are generally displayed within a current window. However, a user may wish content stored within a folder be displayed in a new window when the folder is selected. In such cases, the user will have to manually open a new explorer window, and then navigate to a desired folder in order to cause content in the folder be displayed in the new window. Sometimes, the user can cause content in folders be displayed in a new window by configuring the software (i.e., by accessing a configure-menu) to provide such effect. However, after the software has been so configured, the software will open a folder in a new window every time a folder is selected, and does not allow the user to open a folder in an existing window—unless the software is reconfigured (i.e., by accessing the configure-menu again). As such, existing software do not allow a user to selectively open a folder in a current window or a new window while navigating through content.

### SUMMARY

In accordance with some embodiments, a user interface method includes displaying content associated with an object in a first window if the object is selected by performing a first operation using a mouse and without use of a keyboard, and displaying the content in a second window if the object is selected by performing a second operation using the mouse and without use of the keyboard.

In accordance with other embodiments, a computer program product that includes a medium usable by a processor is provided. The medium includes a set of stored instructions, an execution of which by the processor causes a process to be performed, the process comprising displaying content associated with an object in a first window if the object is selected by performing a first operation using a mouse and without use of a keyboard, and displaying the content in a second window if the object is selected by performing a second operation using the mouse and without use of the keyboard.

In accordance with other embodiments, a user interface includes a first window for presenting information within a screen, and an object in the first window, wherein a selection of the object by performing a first operation using a mouse and without use of a keyboard will cause content associated with the object to be displayed in the first window, and a selection of the object by performing a second operation using the mouse and without use of the keyboard will cause the content to be displayed in a second window.

In accordance with other embodiments, a user interface method includes informing a user, before an object is selected, that content associated with the object will be displayed in a first window if the object is selected, or that the content will be displayed in a second window if the object is selected.

In accordance with other embodiments, a computer program product that includes a medium usable by a processor is provided. The medium includes a set of stored instructions, an execution of which by the processor causes a process to be performed, the process comprising informing a user, before an object is selected, that content associated with the object will be displayed in a first window if the object is selected, or that the content will be displayed in a second window if the object is selected.

In accordance with other embodiments, a user interface includes a first window for presenting an object within a screen, and an indicator for informing a user, before the object is selected, that content associated with the object will be displayed in the first window if the object is selected, or that the content will be displayed in a second window if the object is selected.

In accordance with other embodiments, a user interface method includes informing a user, before an object is selected, that a script will be run if the object is selected, wherein the step of informing comprises presenting information at or adjacent to the object.

In accordance with other embodiments, a computer program product that includes a medium usable by a processor is provided. The medium includes a set of stored instructions, an execution of which by the processor causes a process to be performed, the process comprising informing a user, before an object is selected, that a script will be run if the object is selected, wherein the step of informing comprises presenting information at or adjacent to the object.

In accordance with other embodiments, a user interface includes a first window for presenting an object within a screen, and an indicator located at or adjacent to the object for informing a user, before the object is selected, that a script will be run if the object is selected.

Other aspects and features will be evident from reading the following detailed description of the embodiments.

### BRIEF DESCRIPTION OF THE DRAWINGS

The drawings illustrate the design and utility of embodiments, in which similar elements are referred to by common reference numerals. These drawings depict typical embodiments and are not therefore to be considered to be limiting in the scope of the invention.

FIG. 1 illustrates a user interface for allowing a user to selectively decide how content associated with a hyperlink is to be displayed in accordance with some embodiments;

FIG. 2 illustrates an example of a method of selecting the hyperlink of FIG. 1 to cause content associated with the hyperlink to be displayed in a current window;

FIG. 3 illustrates an example of a method of selecting the hyperlink of FIG. 1 to cause content associated with the hyperlink to be displayed in a new window;

FIG. 4 illustrates a user interface for allowing a user to selectively decide how content stored in a folder is to be displayed in accordance with some embodiments;

FIG. 5 illustrates an example of a method of selecting the folder of FIG. 4 to cause content within the folder to be displayed in a current window;

FIG. 6 illustrates an example of a method of selecting the folder of FIG. 4 to cause content within the folder to be displayed in a new window;

FIG. 7 illustrates a module for allowing a user to decide how content is to be displayed in accordance with some embodiments;

FIG. 8 illustrates a method performed by the module of FIG. 7 in accordance with some embodiments;

FIG. 9 illustrates a user interface having an indicator for informing a user that a selection of a hyperlink will cause content associated with the hyperlink to be displayed in a new window in accordance with some embodiments;

FIG. 10 illustrates a user interface having an indicator for informing a user that a selection of a hyperlink will cause content associated with the hyperlink to be displayed in a current window in accordance with other embodiments;

FIG. 11 illustrates a user interface having an indicator for informing a user that a selection of a hyperlink will cause a script to be run in accordance with other embodiments;

FIG. 12 illustrates a module for modifying a web page in accordance with some embodiments;

FIG. 13 illustrates a user interface having an indicator for informing a user that a selection of a folder will cause content stored in the folder to be displayed in a new window in accordance with some embodiments;

FIG. 14 illustrates a user interface having an indicator for informing a user that a selection of a folder will cause content stored in the folder to be displayed in a current window in accordance with other embodiments;

FIGS. 15-18 illustrate a user interface in accordance with other embodiments;

FIG. 19 illustrates a module for changing a configuration of a pointer or for displaying an indicator in accordance with some embodiments;

FIG. 20 illustrates a method performed by the module of FIG. 19 in accordance with some embodiments;

FIG. 21 illustrates a configuration menu in accordance with some embodiments; and

FIG. 22 is a diagram of a computer hardware system with which embodiments can be implemented.

### DETAILED DESCRIPTION OF THE ILLUSTRATED EMBODIMENTS

Various embodiments are described hereinafter with reference to the figures. It should be noted that the figures are not drawn to scale and that elements of similar structures or functions are represented by like reference numerals throughout the figures. It should also be noted that the figures are only intended to facilitate the description of specific embodiments. They are not intended as an exhaustive description of the invention or as a limitation on the scope of the invention. In addition, an illustrated embodiment needs not have all the aspects or advantages shown. An aspect or an advantage described in conjunction with a particular embodiment is not necessarily limited to that embodiment and can be practiced in any other embodiments even if not so illustrated or described.

User-Prescribed Display Selection

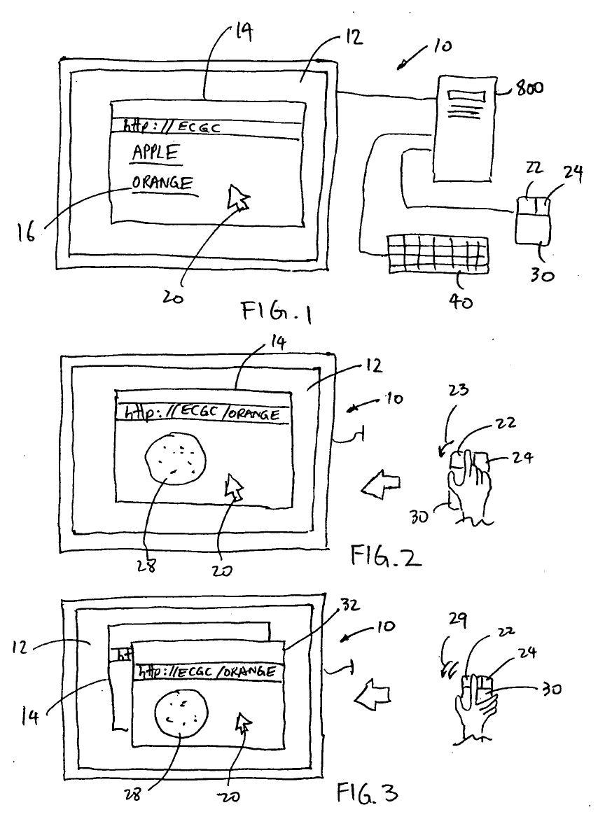

FIG. 1 illustrates a user interface 10 for allowing a user to access content in accordance with some embodiments. The interface 10 includes a window (or frame) 14 for presenting information within a screen 12, and an object 16 located within the window 14. The object 16 is associated with content to be displayed, and can be selected by using a pointer 20. In the illustrated embodiments, the object 16 is a hyperlink, a selection of which by the pointer 20 will cause content, such as web page content, associated with the object 16 to be displayed. As used in this specification, the term “hyperlink” refers to an object (such as a text, a sentence, a symbol, or an item), a selection of which will cause content associated with the object to be displayed.

The object 16 can be selected by a user in two ways. In the illustrated embodiments, the object 16 can be selected by using a mouse 30 to position the pointer 20 at or adjacent the object 16, and single-clicking (as indicated by arrow 23) a first mouse button 22, thereby causing content 28 associated with the object 16 to be displayed in the window 14 (the current window) (FIG. 2). In the illustrated example, the associated content 28 is an image of an orange, but it should be understood by those skilled in the art that the associated content 28 can be any graphics or information. The object 16 can also be selected by positioning the pointer 20 at or adjacent the object 16, and double-clicking (as indicated by arrows 29) the first mouse button 22, thereby causing the content 28 associated with the object 16 to be displayed in a second window 32 (a new window) (FIG. 3). The second window 32 can be automatically placed on top of the first window 14 as shown in the figure, behind the first window 14, or next to the first window 14 (e.g., in a side-by-side arrangement). In other embodiments, instead of displaying the second window 32 in a “restore/customized” format (as that illustrated), the second window 32 can be displayed in a maximized format or a minimized format. In the case of the minimized format, the second window 32 can be represented as a bar or a box, for examples, at a bottom of a screen. As such the term “window” is not limited to an object having a window or frame-like configuration, and can refer to an object having another configuration, such as a scrolled-down bar that represents the window. In alternative embodiments, single-clicking the first mouse button 22 will cause content 28 to be displayed in the second window 32, and double-clicking the first mouse button 22 will cause content 28 to be displayed in the first window 14.

By allowing the object 16 to be selected in two different manners using the mouse 30, a user can conveniently and selectively decide how content 28 associated with the object 16 will be displayed. Also, allowing the user to selectively decide how content associated with a hyperlink is to be displayed simply by selecting the hyperlink in different manners is much more efficient than requiring the user to access a configure-menu to change a display option. In addition, prescribing how to display the content 28 using the mouse 30 and without use of a keyboard 40 is advantageous because a user will not need to take his/her eyes away from the screen 12 to search for a key in the keyboard 40. Choosing how to display content 28 using the mouse 30 and without use of the keyboard 40 is also advantageous in that the user can reserve his/her other hand to perform other tasks, such as, holding a book, a phone, a cup, etc. Further, the above embodiments allow user to selectively decide how content associated with a hyperlink is to be displayed without using a menu, thereby making it more convenient and user-friendly to control how content is to be displayed.

Although the above embodiments have been described with reference to performing different operations using the first mouse button 22, in other embodiments, the object 16 can be selected using a second mouse button 24. For example, in other embodiments, the operations of the mouse 30 described previously can be performed using a second mouse button 24 instead of the first mouse button 22. Also, in other embodiments, a first method of selecting the object 16 can include single-clicking the first mouse button 22, while a second method of selecting the object 16 can include single-clicking the second mouse button 24. Alternatively, a first method of selecting the object 16 can include single-clicking the first mouse button 22, while a second method of selecting the object 16 can include double-clicking the second mouse button 24, or vice versa. In further embodiments, a method of selecting the object 16 can include holding down one of the buttons 22, 24, or clicking one of the buttons 22, 24 after the other.

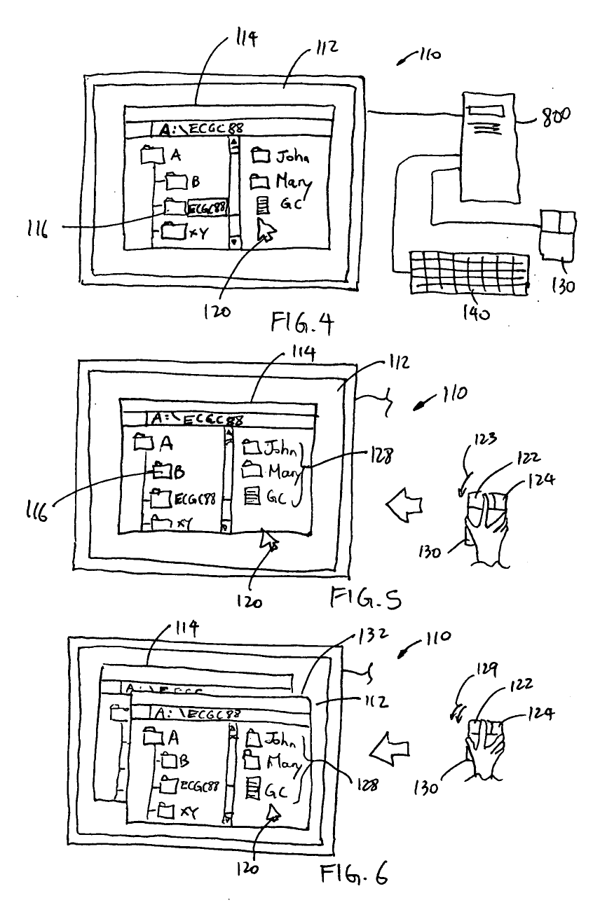

It should be noted that the scope of the invention should not be limited to the object 16 being a hyperlink. In alternative embodiments, the object 16 can be other objects, such as a folder identifier. FIGS. 4-6 illustrates a user interface 110 for allowing a user to access content in accordance with other embodiments. The interface 110 includes a window (or frame) 114 for presenting information within a screen 112, and an object 116 located within the window 114. The object 116 is associated with content to be displayed, and can be selected by using a pointer 120. In the illustrated embodiments, the object 116 is a folder (or folder identifier), a selection of which by the pointer 120 will cause content, such as sub-folder(s) and/or file(s), stored within the folder to be displayed.

The object 116 can be selected by a user in two ways. In the illustrated embodiments, the object 116 can be selected by using a mouse 130 to position the pointer 120 at or adjacent the object 116, and single-clicking (as indicated by arrow 123) a first mouse button 122, thereby causing content 128 associated with the object 116 to be displayed in the window 114 (the current window) (FIG. 5). The object 116 can also be selected by positioning the pointer 120 at or adjacent the object 116, and double-clicking (as indicated by arrows 129) the first mouse button 122, thereby causing the content 128 associated with the object 116 to be displayed in a second window 132 (a new window) (FIG. 6). The second window 132 can be automatically placed on top of the first window 114 as shown in the figure, behind the first window 14, or next to the first window 114 (e.g., in a side-by-side arrangement). In other embodiments, instead of displaying the second window 132 in a “restore/customized” format, the second window 132 can be displayed in a maximized format or a minimized format. In the case of the minimized format, the second window 32 can be represented as a bar or a box, for examples, at a bottom of a screen, as similarly discussed previously. In alternative embodiments, single-clicking the first mouse button 122 will cause content 128 to be displayed in the second window 132, and double-clicking the first mouse button 122 will cause content 128 to be displayed in the first window 114.

By allowing the object 116 to be selected in two different manners using the mouse 130, a user can conveniently and selectively decide how content 128 associated with the object 116 will be displayed. Also, allowing the user to selectively decide how content stored within a folder is to be displayed simply by selecting the folder in different manners is much more efficient than requiring the user to access a configure-menu to change a display option. In addition, prescribing whether to display the content 128 using the mouse 130 and without use of a keyboard 140 is advantageous because a user will not need to take his/her eyes away from the screen 112 to search for a key in the keyboard 140. Choosing how to display content 128 using the mouse 130 and without use of the keyboard 140 is also advantageous in that the user can reserve his/her other hand to perform other tasks, such as, holding a book, a phone, a cup, etc.

Although the above embodiments have been described with reference to performing different operations using the first mouse button 122, in other embodiments, the object 116 can be selected using a second mouse button 124. For example, in other embodiments, the operations of the mouse 130 described previously can be performed using a second mouse button 124 instead of the first mouse button 122. Also, in other embodiments, a first method of selecting the object 116 can include single-clicking the first mouse button 122, while a second method of selecting the object 116 can include single-clicking the second mouse button 124. Alternatively, a first method of selecting the object 116 can include single-clicking the first mouse button 122, while a second method of selecting the object 116 can include double-clicking the second mouse button 124, or vice versa. In further embodiments, a method of selecting the object 116 can include holding down one of the buttons 122,124, or clicking one of the buttons 122, 124 after the other.

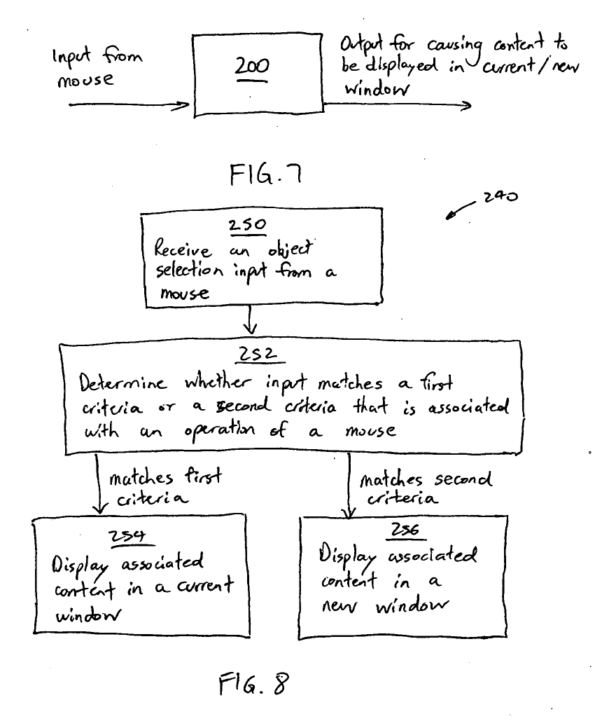

FIG. 7 illustrates a module 200 for allowing a user to decide how content associated with a graphic is to be displayed upon selection of the graphic. As shown in FIG. 7, the module 200 is configured to receive input from a mouse (e.g., mouse 30 or 130), and generate an output for causing content to be displayed in an existing window or a new window based on the received input. FIG. 8 illustrates a method 240 performed by the module 200 in accordance with some embodiments. First, the module 200 receives an object selection input from a mouse (e.g., mouse 30 or 130) (Step 250). Next, the module 200 determines whether the input matches a first criteria associated with a first prescribed operation (e.g., single-clicking) of the mouse or a second criteria associated with a second prescribed operation (e.g., double-clicking) of the mouse (Step 252). If the input matches the first criteria, the module 200 then causes content associated with the selected object to be displayed in a current window, as illustrated in FIG. 2 or 4 (Step 254). On the other hand, if the input matches the second criteria, the module 200 then causes the content to be displayed in a new window, as illustrated in FIG. 3 or 6 (Step 256).

In some embodiments, the module 200 can be implemented using software. For examples, the module 200 can be implemented using software that is loaded onto a computer 800, a server, or other types of memory, such as a disk or a CD-ROM (FIG. 22). In some cases, the module 200 can be implemented as a web application, a component or a plug-in of a browser, a component or a plug-in of an operating system, or a proprietary software application. For example, the module 200 can be implemented using html, java script, or other mark-up or scripting languages. In alternative embodiments, the module 200 can be implemented using hardware. For example, in some embodiments, the module 200 includes an application-specific integrated circuit (ASIC), such as a semi-custom ASIC processor or a programmable ASIC processor. In other embodiments, the module 200 can also be any of a variety of circuits or devices that are capable of performing the functions described herein. For example, in alternative embodiments, the module 200 can include a general purpose processor, such as a Pentium processor. In other embodiments, the module 200 can be implemented using a combination of software and hardware.

In some embodiments, the module 200 also allows a user to determine or choose the first prescribed mouse operation for displaying content in a current window and the second prescribed mouse operation for displaying content in a new window. For example, in some embodiments, the module 200 can provide a configure-menu for allowing a user to select the first and the second prescribed operations from a list of pre-defined mouse operations. Alternatively, the module 200 can provide a configure-menu for allowing a user to define the first and the second prescribed mouse operations.

On Screen Display Indicator

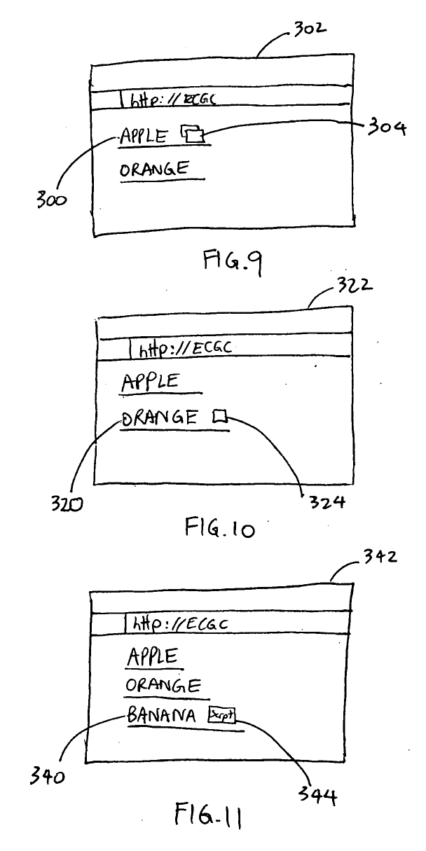

In other embodiments, an object can also have a visual characteristic for indicating to a user how content associated with an object will be displayed upon a selection of the object. FIG. 9 illustrates an object 300, in a form of a hyperlink, displayed in a window 302 (or frame) in accordance with some embodiments. An indicator 304 is displayed in association with the object 300 for indicating to a user how content associated with the object 300 will be displayed upon a selection of the object 300. In the illustrated embodiments, the indicator 304 resembles a new-window that overlays a current window, indicating that content associated with the object 300 will be displayed in a new window upon a selection of the object 300. As such, in the example, if the “Apple” hyperlink is selected, content associated with the “Apple” hyperlink will be displayed in a new window. On the other hand, if the “Orange” hyperlink is selected, content associated with the “Orange” hyperlink will be displayed in the window 302 (the current window).

In other embodiments, an indicator can be displayed in association with the object for indicating to a user that content associated with the hyperlink will be displayed in a current window if the hyperlink is selected. FIG. 10 illustrates an object 320, in a form of a hyperlink, displayed in a window 322 (or frame) in accordance with other embodiments. An indicator 324 is displayed in association with the object 320 for indicating to a user how content associated with the object 320 will be displayed upon a selection of the object 320. In the illustrated embodiments, the indicator 324 resembles a single window, indicating that content associated with the object 320 will be displayed in the window 322 (the current window) upon a selection of the object 320. As such, in the example, if the “Apple” hyperlink is selected, content associated with the “Apple” hyperlink will be displayed in a new window. On the other hand, if the “Orange” hyperlink is selected, content associated with the “Orange” hyperlink will be displayed in the window 322 (the current window).

Providing a display indicator for a hyperlink is advantageous because it allows a user to know (before a hyperlink is selected) how content associated with the hyperlink will be displayed upon a selection. For example, if the current-window indicator 324 is displayed (indicating that associated content will be displayed in a current window upon a selection of the hyperlink), and a user wishes the associated content to be displayed in a new window, the user can take the appropriate action to cause associated content to be displayed in a new window. In some cases, the user can press “shift” followed by clicking a mouse button to cause content to be displayed in a new window. Alternatively, if a user-prescribed display selection feature (discussed previously with reference to (FIGS. 1-8) is provided, the user can perform the prescribed mouse operation to cause associated content to be displayed in a new window.

In other embodiments, a hyperlink can include an indicator for indicating to a user that a script will be invoked/executed if the hyperlink is selected. FIG. 11 illustrates an object 340, in a form of a hyperlink, displayed in a window 342 (or frame) in accordance with other embodiments. An indicator 344 (e.g., a script indicator) is displayed in association with the object 340 for indicating to a user that a script will be run upon a selection of the object 340. In the illustrated embodiments, the indicator 344 is located at or adjacent to the object 340. Such configuration is advantageous in that it allows a user to be aware of an attribute of the object 340 without looking away from the object 340. By means of non-limiting examples, the script may be event driven (e.g., based on onclick, onmouseover, onmousedown, onmouseup, and the like). As discussed previously, in existing applications, attempting to open a new window when selecting a hyperlink that is configured to run a script will cause an error page. As such, providing a script indicator is advantageous because it allows a user to know (before selecting a hyperlink) whether a script will be run upon a selection of the hyperlink. This, in turn will deter a user away from attempting to “open” the hyperlink in a new window. In some embodiments, a backup feature can be provided to further prevent the error page. For example, in some cases, if a user attempts to open (e.g., by pressing “shift” and clicking a mouse button) a hyperlink (that is configured to run a script) in a new window, a module can be used to override the user's command, and run the script of the hyperlink in a current window instead. Alternatively, the module can simply cause the user's command to be ignored. In further embodiments, the module can allow the window to be opened, but run the script in the context of the new window. For example, when a user presses “shift” and clicks a mouse button against a hyper (that is configured to run a script), the module will allows the new window to be opened, and runs the script in the context of the new window. The module can be implemented using software, hardware, or combination of software and hardware, and can be any of the modules described herein.

It should be noted that the indicators 304, 324, and 344 should not be limited to the examples illustrated previously, and that in other embodiments, the indicators 304, 324, and 344 can have other shapes and configurations. For example, any of the indicators 304, 324, 344 can include a symbol, a text, a number, a graph, and/or other graphical elements. Also, instead of using an indicator, in other embodiments, the hyperlink can have a characteristic for indicating to a user how content associated with a hyperlink will be displayed (or that a script will be run). For examples, a hyperlink can have a certain color, or a certain font size/type, for indicating whether a selection of the hyperlink (1) will have content displayed in a current window, (2) will have content displayed in a new window, or (3) will run a script. In addition, any of the indicators 304, 324, 344 can be a component of a hyperlink, or a separate item from a hyperlink. As such, the term, “object” can refer to a hyperlink, or a combination of a hyperlink and an indicator (e.g., any of the indicators 304, 324, 344).

Although the indicators 304, 324, 344 have been discussed separately in various embodiments, it should be noted that in some embodiments, one or more of the indicators 304, 324, 344 can be displayed in a web page. Similarly, in other embodiments, a web page can have a plurality of hyperlinks having different characteristics for indicating whether selection of the hyperlinks will have associated content displayed in a current window, have associated content displayed in a new window, or run a script.

In some embodiments, the characteristic of a hyperlink, or any of the display indicators 304, 324, 344 for indicating how content will be displayed (e.g., in a current or a new window) or whether a script will be run, can be implemented while a web page is created (e.g., by HTML language, java script, a mark-up language, a script language, or other programming language). Alternatively, the characteristic of a hyperlink or any of the indicators 304, 324, 344 can be subsequently provided by a module. FIG. 12 illustrates a module 350 for changing a characteristic of a link or for displaying an indicator. As shown in FIG. 12, the module 350 is configured to analyze web content, e.g., a web page, to determine whether each hyperlink in the web page is configured to display associated content in a current window or a new window, and modify the web page such that display information regarding one or more hyperlink is indicated to a user. For example, the module 350 can add an indicator (e.g., the new-window indicator 304 or the current-window indicator 324) next to a hyperlink, or change a characteristic of the hyperlink, for indicating to a user how content associated with the hyperlink will be displayed if the hyperlink is selected.

In other embodiments, the module 350 can also be configured to analyze a web page to determine whether a selection of a hyperlink in the web page will cause a script to be run, and modify the web page such that the information regarding the running of the script is indicated to a user. For example, the module 350 can add the script indicator 344 next to a hyperlink, or change a characteristic of the hyperlink, for indicating to a user that a selection of the hyperlink will cause a script to be run. Various techniques can be used to determine whether a selection of a hyperlink will cause a script to be run. For example, the module 350 can be configured to detect script command(s) associated with link(s)/object(s) in a web page. In some cases, the browser or a plug-in can analyze and detect a script. Alternatively, the browser or a plug-in can be configured for allowing an author of content to indicate a script. If a script command is detected, the module 350 then displays a script indicator in association with the corresponding link/object. In some embodiments, the module 350 can further display information regarding a characteristic of the detected script. For example, the module 350 can be configured to display the script command as a component of the script indicator 344. In other cases, the module 350 can be configured to display a description of at least a portion of the script as a component of the script indicator 344.

In some embodiments, the module 350 can be implemented using software. For examples, the module 350 can be implemented using software that is loaded onto a computer 800, a server, or other types of memory, such as a disk or a CD-ROM (FIG. 22). In some cases, the module 350 can be implemented as a web application, a component or a plug-in of a browser, a component or a plug-in of an operating system, or a proprietary software application. In alternative embodiments, the module 350 can be implemented using hardware or combination of hardware and software.

In some embodiments, the module 350 also allows a user to determine how display information and/or script information associated with a hyperlink will be presented. For example, in some embodiments, the module 350 can provide a configure-menu for allowing a user to select the indicators 304, 324, and/or 344 from a list of available indicators. Alternatively, the module 350 can provide a configure-menu for allowing a user to create the indicators 304, 324, and/or 344. Also, in other embodiments, the module 350 can allow a user to select colors, font sizes, and/or font types, of a hyperlink, that will be used to indicate how content associated with the hyperlink will be displayed or whether a script will be run upon a selection of the hyperlink.

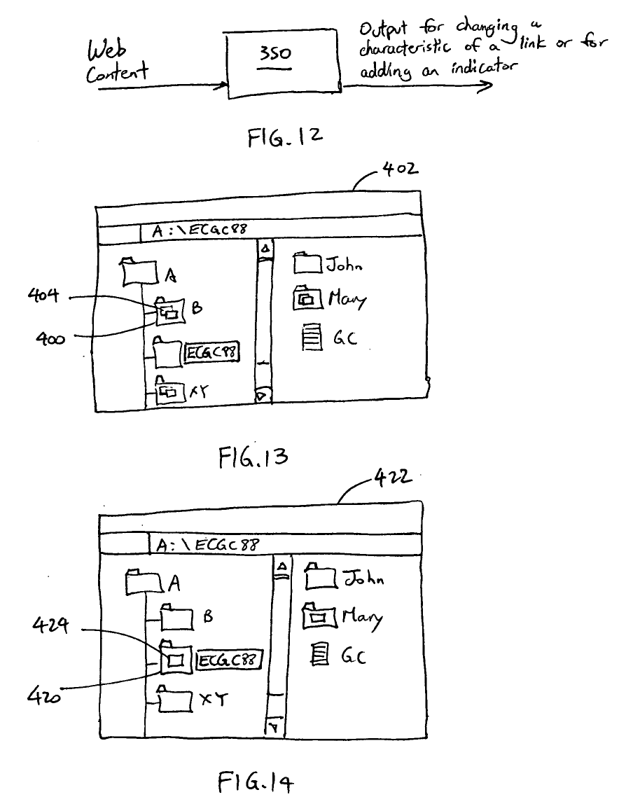

It should be noted that the scope of the invention should not be limited to the object being a hyperlink. In alternative embodiments, the object can be other things, such as a folder identifier. FIG. 13 illustrates an object 400, in a form of a folder identifier, displayed in a window 402 (or frame) in accordance with some embodiments. An indicator 404 is displayed in association with the object 400 for indicating to a user how content associated with the object 400 will be displayed upon a selection of the object 400. In the illustrated embodiments, the indicator 404 resembles a new window that overlays a current window, indicating that content associated with the object 400 will be displayed in a new window upon a selection of the object 400. As such, in the example, if the “B” folder is selected, content stored in the “B” folder will be displayed in a new window. On the other hand, if the “ECGC88” folder is selected, content stored in the “ECGC88” folder will be displayed in the window 402 (the current window).

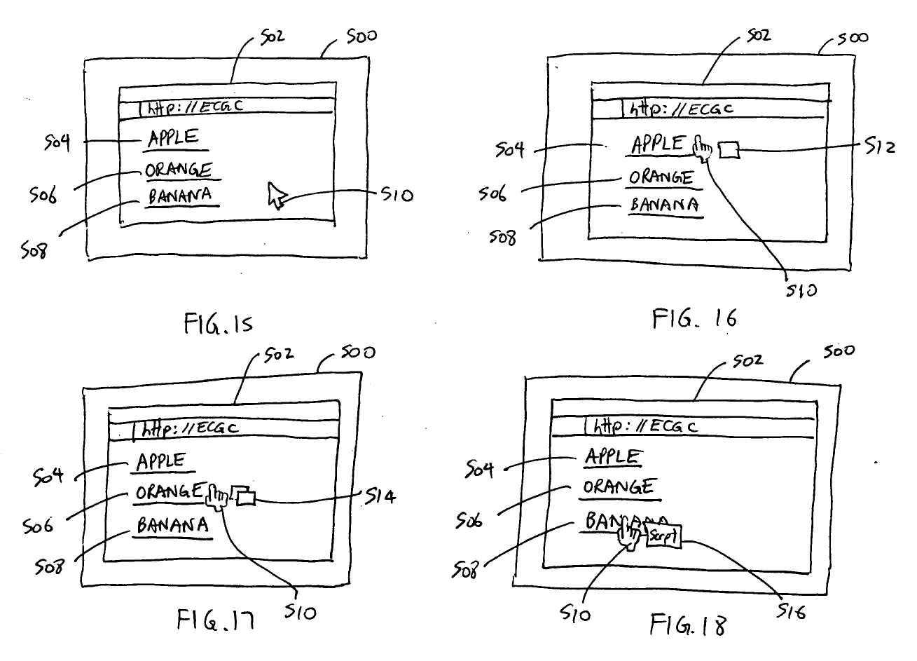

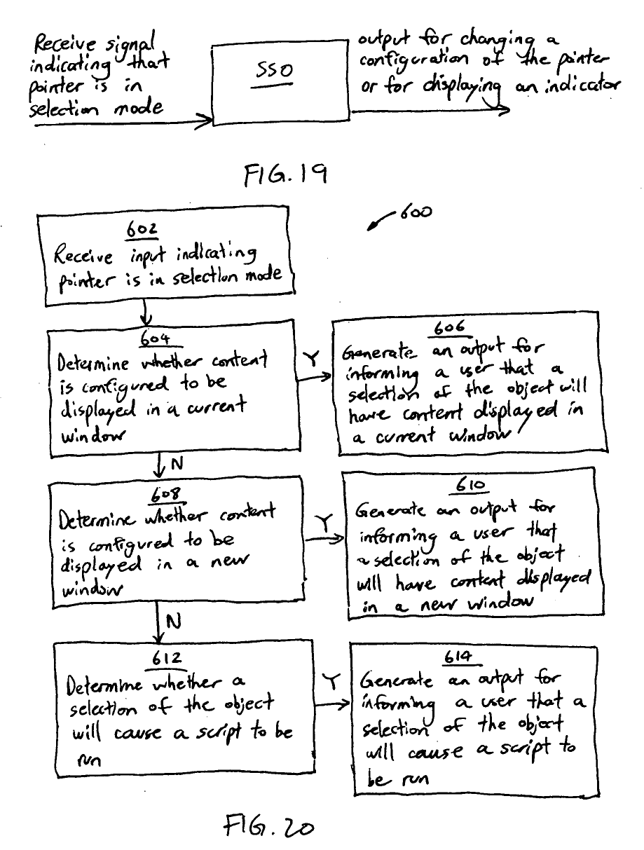

In other embodiments, an indicator can be displayed for indicating to a user that content stored in the folder will be displayed in a current window if the folder is selected. FIG. 14 illustrates an object 420, in a form of a folder identifier, displayed in a window 422 (or frame) in accordance with other embodiments. An indicator 424 is displayed in association with the object 420 for indicating to a user how content associated with the object 420 will be displayed upon a selection of the object 420. In the illustrated embodiments, the indicator 424 resembles a single window, indicating that content associated with the object 420 will be displayed in the window 422 (the current window) upon a selection of the object 420. As such, in the example, if the “ECGC88” folder is selected, content associated with the “ECGC88” folder will be displayed in the window 422 (the current window). On the other hand, if the “B” folder is selected, content within the “B” folder will be displayed in a new window.

In some embodiments, the software program providing the folder identifier(s)/object(s) also allows a user to specify whether contents within a folder is to be displayed in a current window or a new window if the folder is selected. For example, the software program can request a user to input a display preference (e.g., whether to display content in a current window or in a new window) associated with a folder when the user is creating the folder. Alternatively, a user can subsequently specify how contents within a folder is to be displayed by accessing a property menu associated with the folder. After a display preference has been assigned to a folder, the software program then automatically displays a new-window indicator (e.g., the indicator 404) or a current-window indicator (e.g., the indicator 424) next to the folder, depending on the prescribed display preference.

In alternative embodiments, a separate module can be provided that allows a user to specify whether contents within a folder is to be displayed in a current window or a new window. In such cases, the module is a “plug-in” or an “add-on” that operates in conjunction with the software program that provides the folder identifier(s). The module can request a user to input a display preference. (e.g., whether to display content in a current window or in a new window) associated with a folder when the user is creating the folder. Alternatively, a user can subsequently specify how contents within a folder is to be displayed by accessing a property menu (provided by the module) associated with the folder. After a display preference has been assigned to a folder, the module then automatically displays a new window indicator or a current window indicator next to the folder, depending on the prescribed display preference.

Providing a new window indicator or a current window indicator is advantageous because it allows a user to know (before a folder identifier is selected) how content stored within the folder will be displayed upon a selection of the folder. For example, if a current window indicator is displayed (indicating that associated content will be displayed in a current window upon a selection of the folder), and a user wishes the content within the folder to be displayed in a new window, the user can take the appropriate action to cause the content to be displayed in a new window. In some cases, the user can press “shift” followed by clicking a mouse button to cause content to be displayed in a new window. Alternatively, if the user prescribed display selection feature (discussed previously with reference to (FIGS. 1-8) is provided, the user can perform the prescribed mouse operation to cause content within a folder to be displayed in a new window.

It should be noted that the indicators 404 and 424 should not be limited to the examples illustrated previously, and that in other embodiments, the indicators 404 and 424 can have other shapes and configurations. For example, any of the indicators 404, 424 can include a symbol, a text, a number, a graph, and/or other graphical elements. Also, instead of using an indicator, in other embodiments, the folder can have a characteristic for indicating to a user how content stored within the folder will be displayed. For examples, a folder can have a certain color, a certain size/shape, or a certain font size/type for the folder name, for indicating whether a selection of the folder will have stored content displayed in a current window or in a new window. In addition, instead of displaying an indicator in the folder symbol as that shown in the figures, in alternative embodiments, any of the indicators 404, 424 can be displayed beyond the folder symbol (e.g., next to a folder name). Further, any of the indicators 404, 424 can be a component of a folder identifier, or a separate item from a folder identifier. As such, the term, “object” can refer to a folder identifier, or a combination of a folder identifier and an indicator (e.g., any of the indicators 402, 424).

Although the indicators 404, 424 have been discussed separately in various embodiments, it should be noted that in some embodiments, a window can have a plurality of folders having different indicators for indicating whether selection of the folders will have stored content displayed in a current window, or in a new window. Similarly, in other embodiments, a window can have a plurality of folders having different characteristics for indicating whether selection of the folders will have stored content displayed in a current window, or in a new window.

Dynamic Pointer

In some embodiments, display information regarding an object can be provided to a user using a pointer. FIG. 15 illustrates an example of a web page having objects 504, 506, 508 in a window 502 (or frame) that is displayed within a screen 500. The objects 504, 506, 508 are hyperlinks. In the illustrated example, content associated with the hyperlink 504 is configured to be displayed in a current window (i.e., the window 502) upon a selection of the hyperlink 504, content associated with the hyperlink 506 is configured to be displayed in a new window upon a selection of the hyperlink 506, and a script will be run upon a selection of the hyperlink 508. The screen 500 further includes a pointer 510 that can be positioned-using a mouse. As shown in FIG. 15, the pointer 510 resembles an arrow when the pointer 510 is positioned away from the hyperlinks 504, 506, 508 (i.e., when the pointer 510 is in a non-selection mode). When the pointer 510 is in the non-selection mode, an object cannot be selected by using a mouse button. In alternative embodiments, instead of resembling an arrow, the pointer 510 can have other shapes or configurations when in the non-selection mode.

When the pointer 510 is positioned at or adjacent to the hyperlink 504, the pointer 510 changes configuration to indicates that the pointer 510 is now in a selection mode (FIG. 16). When the pointer 510 is in the selection mode, an object can be selected by using a mouse button. In the illustrated example, the pointer 510 has a shape that resembles a pointing-finger when in the selection mode, indicating to a user that the object 504 is selectable. Also, when the pointer 510 is in the selection mode, an indicator 512 (a current-window indicator) is displayed for indicating to the user that content associated with the object 504 will be displayed in a current window when the object 504 is selected.

When the pointer 510 is positioned at or adjacent to the hyperlink 506, the pointer 510 also changes to the pointing-finger configuration to indicate that the pointer 510 is now in a selection mode (FIG. 17). However, in such case, an indicator 514 (a new-window indicator) is displayed for indicating to the user that content associated with the object 506 will be displayed in a new window when the object 506 is selected.

Providing a display indicator is advantageous because it allows a user to know (before a hyperlink is selected) how content associated with the hyperlink will be displayed upon a selection. For example, if a current-window indicator 512 is displayed (indicating that associated content will be displayed in a current window upon a selection of the hyperlink), and a user wishes the associated content to be displayed in a new window, the user can take the appropriate action to cause associated content to be displayed in a new window. In some cases, the user can press “shift” followed by clicking a mouse button to cause content to be displayed in a new window. Alternatively, if the user prescribed display selection feature (discussed previously with reference to (FIGS. 1-8) is provided, the user can perform the prescribed mouse operation to cause associated content to be displayed in a new window.

In another alternative, when the pointer 510 is positioned at or adjacent to the hyperlink 508, the pointer 510 changes to the pointing-finger configuration to indicate that the pointer 510 is now in a selection mode (FIG. 18). However, in such case, an indicator 516 (a script indicator) is displayed for indicating to the user that a script will be run when the object 508 is selected. In some embodiments, the indicator 516 can further include information regarding a characteristic of the script. For example, a script command can be included as a component of the script indicator 514. In other cases, the indicator 514 can include a description of at least a portion of the script. Locating the indicator 516 at or adjacent to the pointer 510 is advantageous because it allows a user to be aware of the attribute of the object 508 without looking away from the object 508.

It should be noted that the indicators 512, 514, and 516 should not be limited to the examples illustrated previously, and that in other embodiments, the indicators 512, 514, and 516 can have other shapes and configurations. For example, any of the indicators 512, 514, 516 can include a symbol, a text, a number, a graph, and/or other graphical elements. Also, instead of using an indicator, in other embodiments, the changed pointer 510 (when in a selection mode) can have a characteristic for indicating to a user how content associated with a hyperlink will be displayed, or that a script will be run. For examples, the changed pointer 510 can have a certain color, or a certain size, for indicating whether a selection of the hyperlink will have content displayed in a current window, have content displayed in a new window, or run a script. In other embodiments, instead of having the pointing-finger configuration, the pointer 510 can have other configurations when in the selection mode. In addition, any of the indicators 512, 514, 516 can be a component of a changed pointer, in which cases, the pointer 510 may or may not include the pointing-finger symbol when in the selection mode. Alternatively, any of the indicators 512, 514, 516 can be a separate item from the pointer. In such cases, any of the indicators 512, 514, 516 can be located at or adjacent to the pointer 510, or the object at which the pointer 510 is pointing.

Although three hyperlinks 504, 506, 508 are shown in the example, it should be understood that a web page may include different numbers of hyperlinks, and that a web page may or may not include any of the three types of hyperlinks (i.e., hyperlink configured to have content displayed in a current window, hyperlink configured to have content displayed in a new window, and hyperlink configured to have a script run) discussed previously.

It should be noted that the scope of the invention should not be limited to an object (e.g., object 504 or 506) being a hyperlink. In alternative embodiments, the object (e.g., object 504 or 506) can be other things, such as a folder identifier, as similarly discussed previously. For example, if a folder is configured to have stored content displayed in a current window, then positioning a pointer at or adjacent to the folder will cause the current-window indicator 512 to be displayed (or cause the pointer to change its configuration) for indicating to a user that a selection of the folder will have stored content in the folder displayed in the current window. On the other hand, if a folder is configured to have stored content displayed in a new window (or frame), then positioning a pointer at or adjacent to the folder will cause the new-window indicator 514 to be displayed (or cause the pointer to change its configuration) for indicating to a user that a selection of the folder will have stored content in the folder displayed in a new window.

FIG. 19 illustrates a module 550 for changing a configuration of a pointer, or for displaying an indicator, when the pointer is in a selection mode. As shown in FIG. 19, the module 550 is configured to receive a signal indicating that a pointer is in a selection mode, and generate an output for changing a configuration of the pointer based on an attribute of an object. Alternative, the module 550 can be configured to display an indicator (e.g., any of the indicators 512, 514, 516) based on an attribute of the object. FIG. 20 illustrates a method 600 performed by the module 550 in accordance with some embodiments. First, the module 550 receives an input indicating that a pointer is in a selection mode (i.e., the pointer is located at or adjacent to an object, such as a hyperlink or a folder identifier, that can be selected) (Step 602). Next, the module 550 determines whether content associated with the object is configured to be displayed in a current window (Step 604). If so, the module 550 then generates an output for causing the current-window indicator 512 to be displayed (or for causing the pointer to change configuration) for indicating to a user that a selection of the object will have associated content displayed in the current window (Step 606). If associated content is not configured to be displayed in the current window, the module 550 then determines whether content associated with the object is configured to be displayed in a new window (Step 608). If so, the module 550 then generates an output for causing the new-window indicator 514 be displayed (or for causing the pointer to change configuration) for indicating to a user that a selection of the object will have associated content displayed in a new window (Step 610). If associated content is not configured to be displayed in a new window, the module 550 then determines whether a selection of the object will cause a script to be run (Step 612). If so, the module 550 then generates an output for causing the script indicator 516 to be displayed (or for causing the pointer to change configuration) for indicating to a user that a selection of the object will cause a script to be run (Step 614). It should be noted that the order of the steps in the method 600 should not be limited to that illustrated, and that in alternative embodiments, the steps in the method 600 can have different order. Also, in other embodiments, the method 600 needs not include all of the steps illustrated. For example, in some embodiments, the method 600 does not include steps 612, 614. In other embodiments, the method 600 does not include steps 604, 606, 608, 610. Further, in alternative embodiments, one or more steps in the method 600 can be further divided into sub-steps.

In some embodiments, the module 550 can be implemented using software. For examples, the module 550 can be implemented using software that is loaded onto a computer 800, a server, or other types of memory, such as a disk or a CD-ROM (FIG. 22). In other embodiments, the module 550 can be implemented as a web application, a component or a plug-in of a browser, a component or a plug-in of an operating system, or a proprietary software application. In further embodiments, the browser itself can be implemented to provide the functionalities of the module 550. In alternative embodiments, the module 550 can be implemented using hardware or combination of hardware and software.

In some embodiments, the module 550 also allows a user to determine or choose how display information and/or script information associated with an object will be presented. For example, in some embodiments, the module 550 can provide a configure-menu for allowing a user to select the indicators 512, 514, and/or 516 from a list of available indicators. Alternatively, the module 550 can provide a configure-menu for allowing a user to create the indicators 512, 514, and/or 516. Also, in other embodiments, the module 550 can allow a user to select configurations (e.g., shapes, colors and/or sizes) of the changed pointer 510, that will be used to indicate how content associated with an object will be displayed or whether a script will be run upon a selection of an object.

Feature Selection Menu

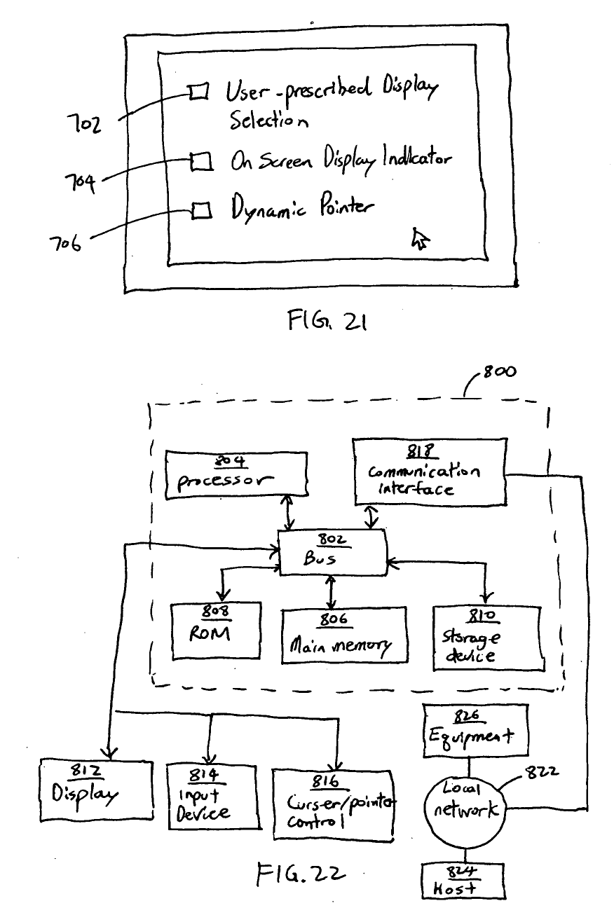

In some embodiments, a module can be provided that allows a user to select one of the features (i.e., the “User-prescribed Display Selection” feature, the “On Screen Display Indicator” feature, and the “Dynamic Pointer” feature) described previously with reference to FIGS. 1-8, FIGS. 9-14, and FIGS. 15-20, respectively. FIG. 21 illustrates a menu 700 in accordance with some embodiments. The menu 700 includes a first box 702, a selection of which will cause the “User-prescribed Display Selection” feature be selected, a second box 704, a selection of which will cause the “On Screen Display Indicator” feature be selected, and a third box 706, a selection which will cause the “Dynamic Pointer” feature be selected. In some embodiments, the menu 700 can be a sub-menu or a pull-down menu in a web-browser. Alternatively, the menu 700 can be a sub-menu or a pull-down menu in a navigation tool. In further alternative, the menu 700 can be accessed by clicking one of the mouse buttons (e.g., a right mouse button) while operating a pointer. In other embodiments, the menu 700 can be provided by a proprietary software. It should be noted that the configuration of the menu 700 should not be limited to the example illustrated, and that the menu 700 can have other configurations in other embodiments. For example, instead of check-boxes, the menu 700 can include a pull-down menu.

Computer Architecture

FIG. 22 is a block diagram that illustrates an embodiment of a computer system 800 upon which embodiments described herein may be implemented. Computer system 800 includes a bus 802 or other communication mechanism for communicating information, and a processor 804 coupled with bus 802 for processing information. Computer system 800 also includes a main memory 806, such as a random access memory (RAM) or other dynamic storage device, coupled to bus 802 for storing information and instructions to be executed by processor 804. Main memory 806 also may be used for storing temporary variables or other intermediate information during execution of instructions to be executed by processor 804. Computer system 800 may further include a read only memory (ROM) 808 or other static storage device coupled to bus 802 for storing static information and instructions for processor 804. A data storage device 810, such as a magnetic disk or optical disk, is provided and coupled to bus 802 for storing information and instructions.

Computer system 800 may be coupled via bus 802 to a display 812, such as a cathode ray tube (CRT), for displaying information to a user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. This input device typically has two degrees of freedom in two axes, a first axis (e.g., x) and a second axis (e.g., y), that allows the device to specify positions in a plane.

In some embodiments, the computer system 800 can be used to provide an interface (e.g., any of the interfaces described herein) for allowing a user to access content (e.g., web content, folder content, etc.). According to some embodiments, such use may be provided by computer system 800 in response to processor 804 executing one or more sequences of one or more instructions contained in the main memory 806. Such instructions may be read into main memory 806 from another computer-readable medium, such as storage device 810. Execution of the sequences of instructions contained in main memory 806 causes processor 804 to perform the process steps described herein. One or more processors in a multi-processing arrangement may also be employed to execute the sequences of instructions contained in main memory 806. In alternative embodiments, hard-wired circuitry may be used in place of or in combination with software instructions to implement features of the interfaces described herein. Thus, embodiments are not limited to any specific combination of hardware circuitry and software.

The term “computer-readable medium” as used herein refers to any medium that participates in providing instructions to processor 804 for execution. Such a medium may take many forms, including but not limited to, non-volatile media, volatile media, and transmission media. Non-volatile media includes, for example, optical or magnetic disks, such as storage device 810. Volatile media includes dynamic memory, such as main memory 806. Transmission media includes coaxial cables, copper wire and fiber optics, including the wires that comprise bus 802. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer-readable media may be involved in carrying one or more sequences of one or more instructions to processor 804 for execution. For example, the instructions may initially be carried on a magnetic disk of a remote computer. The remote computer can load the instructions into its dynamic memory and send the instructions over a telephone line using a modem. A modem local to computer system 800 can receive the data on the telephone line and use an infrared transmitter to convert the data to an infrared signal. An infrared detector coupled to bus 802 can receive the data carried in the infrared signal and place the data on bus 802. Bus 802 carries the data to main memory 806, from which processor 804 retrieves and executes the instructions. The instructions received by main memory 806 may optionally be stored on storage device 810 either before or after execution by processor 804.

Computer system 800 also includes a communication interface 818 coupled to bus 802. Communication interface 818 provides a two-way data communication coupling to a network link 820 that is connected to a local network 822. For example, communication interface 818 may be an integrated services digital network (ISDN) card or a modem to provide a data communication connection to a corresponding type of telephone line. As another example, communication interface 818 may be a local area network (LAN) card to provide a data communication connection to a compatible LAN. Wireless links may also be implemented. In any such implementation,.communication interface 818 sends and receives electrical, electromagnetic or optical signals that carry data streams representing various types of information.

Network link 820 typically provides data communication through one or more networks to other devices. For example, network link 820 may provide a connection through local network 822 to a host computer 824. Network link 820 may also transmits data between an equipment 826 and communication interface 818. The data streams transported over the network link 820 can comprise electrical, electromagnetic or optical signals. The signals through the various networks and the signals on network link 820 and through communication interface 818, which carry data to and from computer system 800, are exemplary forms of carrier waves transporting the information. Computer system 800 can send messages and receive data, including program code, through the network(s), network link 820, and communication interface 818. Although one network link 820 is shown, in alternative embodiments, communication interface 818 can provide coupling to a plurality of network links, each of which connected to one or more local networks. In some embodiments, computer system 800 may receive data from one network, and transmit the data to another network. Computer system 800 may process and/or modify the data before transmitting it to another network.

In other embodiments, instead of a computer system, any of the embodiments described herein can be implemented in other devices, such as hand held devices (phones, personal organizers, cameras, pagers, camcorders, blackberries, digital books, or other electronic devices that have a display). For example, in some embodiments, a user interface of a cell phone provides a pointer, wherein when the pointer is positioned adjacent to an object (e.g., a name), the user interface will display information (e.g., telephone number, address, last call, talk time, etc.) associated with the object.

Although the above embodiments have been described with reference to informing a user how content associated with an object will be displayed and/or whether a script will be run when an object is selected, in other embodiments, any of the embodiments described herein can also be used to inform a user other attribute(s) of an object. For examples, any of the embodiments described herein can be used to inform a user a size of the content that is associated with an object to be selected, file types (e.g., picture, movie; etc.), or last visited time (and/or date). Also, instead of the object being a hyperlink or a folder identifier, in alternative embodiments, any of the objects described herein can be another item, such as, a picture, an image, a button, a table entry, a menu item, or any of other entities, as long as it is selectable by a pointer.

Although particular embodiments have been shown and described, it will be understood that they are not intended to limit the present inventions, and it will be obvious to those skilled in the art that various changes and modifications may be made. For example, in other embodiments, one or more functions performed by any of the modules 200, 350, 550 may be implemented using one or more processors or one or more software. The specification and drawings are, accordingly, to be regarded in an illustrative rather than restrictive sense. The present inventions are intended to cover alternatives, modifications, and equivalents, which may be included within the spirit and scope of the present inventions as defined by the claims.

What is claimed:

1. A user interface method, comprising:
displaying content associated with an object in a first window if the object is selected by performing a first operation using a mouse and without use of a keyboard, and displaying the content in a second window if the object is selected by performing a second operation using the mouse and without use of the keyboard.

2. The method of claim 1, wherein the performing the first operation comprises one of a single-clicking and a double-clicking a mouse button, and the performing the second operation comprises another of the single-clicking and the double-clicking the mouse button.

3. The method of claim 1, wherein the performing the first operation comprises clicking a first mouse button, and the performing the second operation comprises clicking a second mouse button.

4. The method of claim 1, wherein the object comprises a hyperlink.

5. The method of claim 1, wherein the object comprises a folder identifier.

6. The method of claim 1, wherein the performing the first operation and the performing the second operation each does not comprise operating the mouse to open a configure-menu.

7. A computer program product that includes a medium usable by a processor, the medium having a set of stored instructions, an execution of which by the processor causes a process to be performed, the process comprising:
displaying content associated with an object in a first window if the object is selected by performing a first operation using a mouse and without use of a keyboard, and displaying the content in a second window if the object is selected by performing a second operation using the mouse and without use of the keyboard.

8. A user interface, comprising:
a first window for presenting information within a screen; and
an object in the first window, wherein a selection of the object by performing a first operation using a mouse and without use of a keyboard will cause content associated with the object to be displayed in the first window, and a selection of the object by performing a second operation using the mouse and without use of the keyboard will cause the content to be displayed in a second window.

9. A user interface method, comprising:
informing a user, before an object is selected, that content associated with the object will be displayed in a first window if the object is selected, or that the content will be displayed in a second window if the object is selected.

10. The method of claim 9, wherein the informing comprises displaying the object in the first window, the object having a characteristic for indicating that the content will be displayed in the first window or in the second window.

11. The method of claim 9, wherein the informing comprises displaying an indicator next to the object.

12. The method of claim 11, wherein the indicator is displayed independent of a position of a pointer.

13. The method of claim 11, wherein the indicator is displayed only when a pointer is placed at or adjacent to the object.

14. The method of claim 9, wherein the informing comprises changing a configuration of a pointer.

15. The method of claim 14, wherein the changed configuration of the pointer indicates that the content associated with the object will be displayed in the first window if the object is selected, the first window being a current window.

16. The method of claim 14, wherein the changed configuration of the pointer indicates that the content associated with the object will be displayed in the second window if the object is selected, the second window being a new window.

17. The method of claim 9, wherein the object comprises a hyperlink.

18. The method of claim 9, wherein the object comprises a folder identifier.

19. A computer program product that includes a medium usable by a processor, the medium having a set of stored instructions, an execution of which by the processor causes a process to be performed, the process comprising:
informing a user, before an object is selected, that content associated with the object will be displayed in a first window if the object is selected, or that the content will be displayed in a second window if the object is selected.

20. A user interface, comprising:
a first window for presenting an object within a screen; and
an indicator for informing a user, before the object is selected, that content associated with the object will be displayed in the first window if the object is selected, or that the content will be displayed in a second window if the object is selected.

21. A user interface method, comprising:
informing a user, before an object is selected, that a script will be run if the object is selected;
wherein the step of informing comprises presenting information at or adjacent to the object.

22. The method of claim 21, wherein the informing comprises displaying the object, the object having a characteristic for indicating that the script will be run if the object is selected.

23. The method of claim 21, wherein the informing comprises displaying an indicator next to the object.

24. The method of claim 23, wherein the indicator is displayed independent of a position of a pointer.

25. The method of claim 23, wherein the indicator is displayed only when a pointer is placed at or adjacent to the object.

26. The method of claim 21, wherein the informing comprises changing a configuration of a pointer when the pointer is positioned at or adjacent the object, the changed configuration of the pointer indicating that the script will be run if the object is selected.

27. A computer program product that includes a medium usable by a processor, the medium having a set of stored instructions, an execution of which by the processor causes a process to be performed, the process comprising:
informing a user, before an object is selected, that a script will be run if the object is selected;
wherein the step of informing comprises presenting information at or adjacent to the object.

28. A user interface, comprising:
a first window for presenting an object within a screen; and
an indicator located at or adjacent to the object for informing a user, before the object is selected, that a script will be run if the object is selected.
